(19) United States
(12) Patent Application Publication
(10) Pub. No.: US 2015/0357952 A1
(43) Pub. Date: Dec. 10, 2015

(54) METHOD AND SYSTEM OF TRACKING THE MAXIMUM EFFICIENCY OF A VARIABLE SPEED ENGINE-GENERATOR SET

(71) Applicant: Innovus Power, Inc., Freemont, CA (US)

(72) Inventors: Brendan TAYLOR, Freemont, CA (US); John MCCALL, Freemont, CA (US)

(73) Assignee: INNOVUS POWER, INC., Freemont, CA (US)

(21) Appl. No.: 14/729,562

(22) Filed: Jun. 3, 2015

Related U.S. Application Data
(60) Provisional application No. 62/007,736, filed on Jun. 4, 2014.

(51) Int. Cl. H02P 9/04

(52) U.S. Cl. CPC H02P 9/04

(57) ABSTRACT

A generator system including an engine and an electrical generator. An electronic control unit configured to monitor and control the engine and generator is provided. The electronic control unit is configured to monitor the electrical load being supplied by the generator and to determine whether the load has remained within a predetermined range for a predetermined period of time. The electronic control unit is configured to adjust the speed of the engine by a predetermined amount when the load has been determined to have remained within the predetermined range for a predetermined length of time. The electronic control unit is configured to compare the present rate of fuel consumption for the adjusted speed to a stored value for the rate of fuel consumption corresponding to the present electrical load being applied to the generator and subsequently update the stored value for engine speed based on the results of the comparison.

### CROSS REFERENCE TO RELATED APPLICATIONS

The present application claims priority to and the benefit of U.S. Provisional Patent Application No. 62/007,736, filed on Jun. 4, 2014. The foregoing provisional application is incorporated by reference herein in its entirety.

### BACKGROUND

Some current engine-generator sets (gensets) operate at a relatively constant engine speed regardless of the electrical load applied to the genset. Such gensets use synchronous machines (e.g., generators) directly connected to the engine and an electrical network that uses constant frequency electricity. If, instead, the generator is indirectly connected to the grid through an electronic power converter, the generator and engine can operate at frequencies independent of the grid. Alternatively, the engine may be coupled to the generator via a multispeed or continuously variable transmission, or directly coupled to a doubly fed asynchronous generator. This has the advantage over fixed gensets that the engine operating speed can be set to optimize fuel efficiency at different loads, thereby saving substantial fuel and operating cost. Operating at variable speed also has other benefits, such as reduced maintenance due to improved combustion quality compared to fixed speed gensets.

One way to determine the optimum operating speed of a variable speed genset (VSG) is to create a map of fuel consumption as a function of engine speed and load. This can be done by connecting a VSG to an adjustable load bank and running at the full range of loads and speeds, measuring fuel use and energy production and calculating the specific fuel rate (liters of fuel per kWh of electricity produced). Once the fuel map is created, the most fuel efficient operating point at a specific load can be determined, called the optimum load-speed curve.

Creating a fuel map using an adjustable load bank is a time consuming process because it is necessary to run a large number of tests to fully map the fuel usage to determine the most fuel efficient speed for the range of possible loads. Another problem with this approach is the individual unit being tested may not be representative of all units of that model. Also, as system components degrade over time, the optimum load-speed curve may change in a given unit. As a result, there may be a need to repeat the fuel mapping process during the operational life of the genset (e.g., after an extensive maintenance period or overhaul).

Various additional approaches to determining the optimum operating speed for variable speed engine-generator sets (gensets) have been described and implemented. Some rely on extensive testing of the engine under different load conditions to determine the optimum operating speed. Others rely on extensive knowledge of grid conditions, or energy storage conditions, if used in the system. If the engine performance changes substantially from unit to unit, or over time due to degradation of components, the engine may not be operated at its most optimum operating speed, thereby missing some of the potential fuel savings available through the use of variable speed gensets.

### BRIEF DESCRIPTION OF THE DRAWINGS

Features, aspects, and advantages of the present invention will become apparent from the following description, and the accompanying exemplary embodiments shown in the drawings, which are briefly described below.

FIG. 1A is a schematic block diagram of a variable speed genset coupled to a load, according to an exemplary embodiment.

FIG. 1B is a schematic block diagram of a variable speed genset coupled to a load, according to an exemplary embodiment.

FIG. 2 is a flow chart of a method for tracking the maximum efficiency point of the genset of FIG. 1A or 1B, according to an exemplary embodiment.

### DETAILED DESCRIPTION

A variable-speed genset is disclosed that includes a control system that is configured to continually monitor the performance of the genset and adjust the optimum load-speed curve as needed to produce electricity to service an electrical load. The speed set point of the engine is first set to a previously determined optimum speed for the load. The set point is then varied slightly in either direction (i.e., up or down). The optimum speed table is updated if this variation is found to improve efficiency. In this way, it is possible to continually determine and operate at the optimum operating speed under different load conditions using fuel consumption and power production information from the control system, thereby ensuring that the maximum fuel savings is obtained for each production unit over its entire operational life.

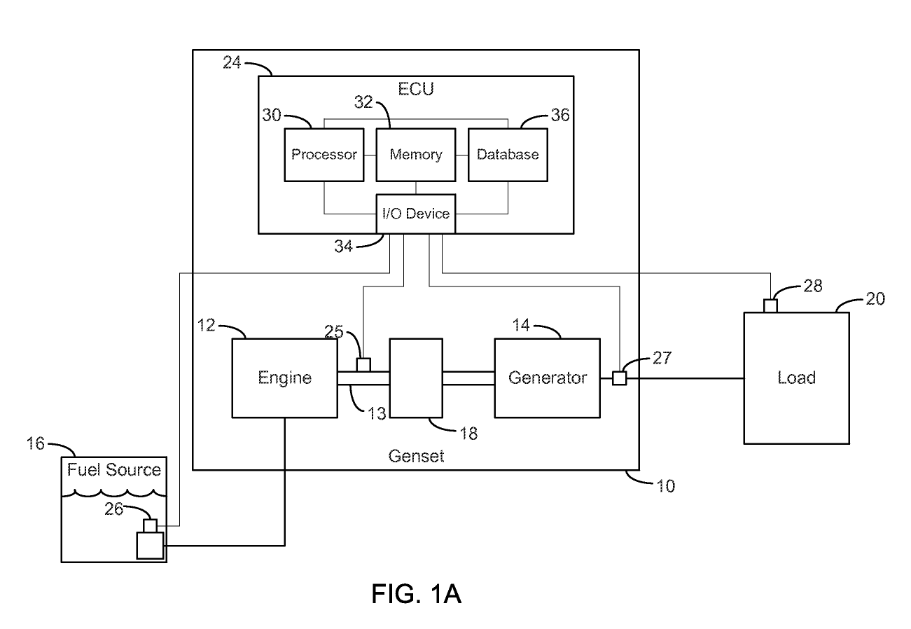

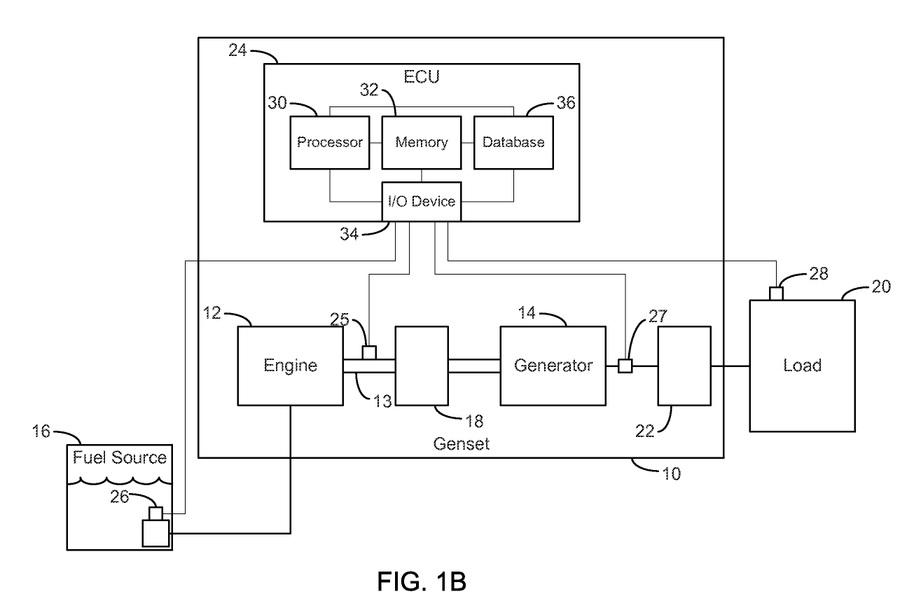

Referring to FIGS. 1A-1B, a genset 10 is shown according to an exemplary embodiment. The genset 10 includes an engine 12 (e.g., an internal combustion engine, diesel engine, etc.) and an electric generator 14. The engine 12 consumes fuel from a fuel source 16 to rotate an output shaft 13 (e.g., drive shaft). The electric generator 14 is coupled to the output shaft 13 of the engine 12 and is rotated to generate an electrical voltage.

According to an exemplary embodiment shown in FIG. 1A, the generator 14 is indirectly coupled to the output shaft 13 of the engine 12, such as with a variable speed transmission 18 (e.g., multispeed transmission, continuously variable transmission, etc.). The indirect coupling of the generator 14 to the engine 12 allows the engine 12 to be operated at a variable speed. The operating speed of the engine 12 may be set to optimize fuel efficiency at different loads and to improve combustion quality, thereby reducing the fuel and maintenance costs of the genset 10.

In another embodiment, the generator 14 may be a doubly fed asynchronous generator having windings on both the stator and the rotor components and may be coupled to the engine 12 without an intermediate device such as the transmission 18.

The genset may include power electronics and a power converter for controlling the output voltage and frequency as well as the engine speed. The power electronics may be implemented in whole or in part in an Electronic Control Unit as described further below. The power converter may include a passive or active rectifier.

The genset 10 is coupled to an electrical load 20. The electrical load 20 may be any device or system that may be provided with electrical energy by the genset 10. In one embodiment, the load 20 may be a single device and the genset 10 may be a dedicated genset 10 powering the device. In another embodiment, the load 20 may be the electrical grid or an isolated electrical network (e.g., microgrid). In some embodiments, the genset 10 may be the sole power source for the load 20. In other embodiments, the genset 10 may be utilized to supplement another power source (e.g., as an emergency back-up power source), or to support or export power to the electrical grid. The genset 10 may be coupled directly to the load 20. In another embodiment, as shown in FIG. 1B, the genset 10 may be indirectly coupled to the load 20 via an intermediate device 22 (e.g., an electronic power converter) allowing the generator 14 and the engine 12 to operate at frequencies independent of the load 20 (e.g., the grid).

The genset 10 includes an engine control unit (ECU) 24. The ECU 24 is configured to monitor and control the operation of the engine 12, (e.g., by controlling the timing of the fuel injection system, the air/fuel mixture, etc.). The ECU 24 includes a processor 30, memory 32, an input/output (I/O) device 34, and a load-speed curve database 36. The processor 30 may be implemented as a general-purpose processor, an application specific integrated circuit (ASIC), one or more field programmable gate arrays (FPGAs), a digital-signal-processor (DSP), a group of processing components, or other suitable electronic processing components. The memory 32 is one or more devices (e.g., RAM, ROM, Flash Memory, hard disk storage, etc.) for storing data and/or computer code for facilitating the various processes described herein. The memory 32 may be or include non-transient volatile memory or non-volatile memory. The memory 32 may include database components, object code components, script components, or any other type of information structure for supporting the various activities and information structures described herein. The memory 32 may be communicably connected to processor 30 and provide computer code or instructions to the processor 30 for executing any of the processes described herein. The I/O device 80 may be any suitable device enabling users to provide outputs to components such as a fuel pump and/or receive inputs from various sensors monitoring the engine 12. The I/O device 80 may include analog/digital and/or digital/analog converters configured to convert signals to/from components or sensors coupled to the ECU 24. The load-speed curve database 36 is configured to store load-speed curves. The curves may be general curves provided by the manufacturer for all gensets of the same model or type or the curves may be individualized curves for the particular genset 10 that are based on testing or prior performance of the genset 10, as described in more detail below.

According to an exemplary embodiment, the ECU 24 is coupled to a rotational speed sensor 25, a fuel rate sensor 26, an output sensor 27, and a load sensor 28. The speed sensor 25 is configured to measure the rotational speed of the output shaft 13. The speed sensor 25 may be, for example, a Hall effect sensor that provides an analog output in the form of a voltage that varies depending on the rotational speed of the output shaft 13. In other embodiments, the speed sensor 25 may be any suitable sensor (e.g., optical sensor, electromechanical sensor, etc.) that provides a varying analog or digital output signal depending on the rotational speed of the output shaft. For example, the speed sensing may be accomplished in the power converter using the voltage waveform produced by the generator. The fuel rate sensor 26 is configured to measure the rate at which fuel is provided to the engine 12 from the fuel source 16. For example, the fuel rate sensor 26 may be an injection pump speed sensor that is configured to monitors the rotational speed of the fuel injection pump. The fuel rate may be reported directly to the ECU 24 by the fuel rate sensor 26 or may be provided to the ECU 24 by a separate device, such as a fuel meter. In some embodiments, the ECU 24 may be coupled to other sensors monitoring the engine 12 (e.g., air pressure sensors, a fuel pressure sensors, vacuum pressure sensors, temperature sensors, etc.). Instead of a sensor detecting the flow of fuel to the engine, the ECU 24 may estimate the rate of fuel consumption based on sensors that detect various properties associated with the fuel supply such as, for example, fuel pressure in the fuel injection system (e.g., fuel rail pressure) and injector dwell time. For example, a fuel consumption rate calculator such as disclosed in U.S. Pat. No. 8,340,925 (incorporated by reference herein) may be employed in the system and ECU 24.

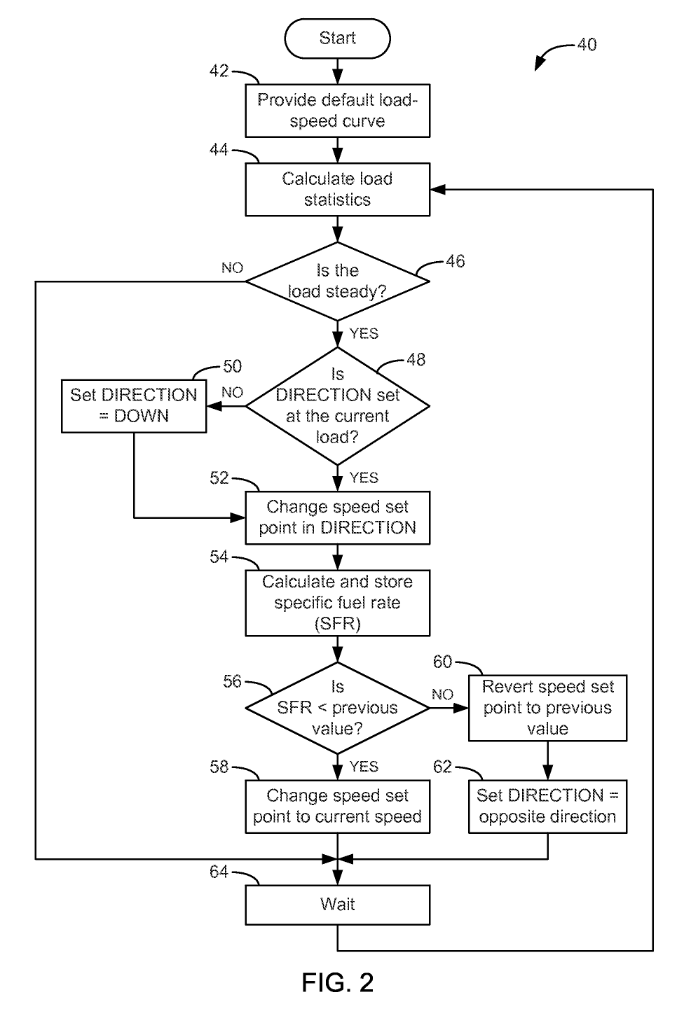

Referring now to FIG. 2, an exemplary method 40 for tracking the maximum efficiency point of the genset 10 is shown, according to one exemplary embodiment. A default load-speed curve (i.e., fuel map) is first provided to the genset 10 (step 42). The default load-speed map may be loaded into the memory 32 of the ECU 24 and may be stored in the memory 32 or in the load-speed curve database 36. The default load-speed curve may be based on a fuel map done with a similar unit, the fuel consumption data supplied by the engine manufacturer, or through any other suitable means. The default load-speed curve provides an initial value to start the optimization process.

The ECU 24 monitors the operation of the engine and the load placed on the genset 10 and calculates the load statistics at the current engine speed (step 44). When the genset 10 encounters a relatively steady load (e.g., a load that varies less than approximately 10 percent) for some period of time (e.g., one minute) (step 46), the ECU 24 checks to see if a direction parameter has been set for the currently sensed load (step 48). The acceptable range of variance of load for determination of whether the load is steady may be based on a predetermined numerical range or a predetermined percentage. Initially, the direction parameter may not be set, and the direction parameter may be set to an arbitrary direction. For example, in one exemplary embodiment, the direction parameter is set to “down” as a starting point (step 50). The ECU then changes a speed set point by a small amount (e.g. 25 RPM) in the set direction (step 52). For example, the speed may be reduced by 25 RPM.

Once operating at that speed and load for some time (e.g., one minute), the system calculates the specific fuel rate (SFR) for the genset 10 using the current rate of fuel being consumed by the engine 12 and the electrical energy being provided by the generator 14 (e.g., reported by the inverter, by a power meter, etc.) (step 54). The control system records this fuel rate for this power level for future reference (e.g., recorded in the memory 32).

The newly calculated SFR is compared to a stored value (step 56). The stored value may be the initial value set by the default load-speed curve or an SFR recorded in a previous iteration of the method 40. With the direction set to down, if the SFR is lower than the previously recorded value, the current engine speed (e.g., as sensed by the speed sensor 25) becomes the new set point in the optimum load-speed curve (step 58). If the SFR is higher than the previously recorded value, the speed set point is returned to the previous value (step 60). The direction parameter is then reversed (step 62). For example, if the current direction parameter is set as “down”, it is changed to “up.” In this way the method may be used to test different SFR values until an optimized SFR is determined.

The ECU 24 then waits a set length of time (e.g., approximately 30 minutes, approximately 60 minutes, approximately 90 minutes) before repeating the process (step 64). The next time the genset 10 is detected to be operating at this power level with a steady load, the method 40 repeats, thereby constantly searching for the maximum efficiency point for each load value.

It should be noted that the method 40 may vary from the specific embodiment illustrated in FIG. 3. For example, in other embodiments, the direction parameter may be set to “up” as a starting point. In other embodiments, there may also be other constraints in the genset 10 and the load 20 that may prevent the genset 10 from operating at its most fuel efficient operating point. For example, it may be necessary to run the engine 12 at a higher-than-optimal speed in order to accept a large, fast increase in the load 20 without substantial power quality degradation. The ECU 24 may be configured to discount such incidents when calculating the maximum efficiency point for a load value.

The method 40 may be repeated using different parameters in subsequent iterations. For example, the amount that the speed set point is varied in step 52 may initially be a relatively large amount to determine a first, rough optimized speed set point. The method may then be repeated with the amount that the speed set point is varied in step 52 being a relatively small amount to determine a second, fine optimized speed set point.

While the ECU 24 of the engine 12 is described as monitoring and controlling the genset to calculate the maximum efficiency for a load value, in other embodiments, the maximum efficiency calculations may be performed by another controller communicating with an existing ECU for an engine 12. The method 40, as described above, may therefore be implemented for an existing genset to increase the efficiency of the genset.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

It is important to note that the construction and arrangement of the method for tracking the maximum efficiency point of a variable speed engine-generator set as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A method of operating a generator set including an engine and electrical generator, wherein an electronic control unit is configured to control the operation of the generator set and is configured to control the speed of the engine based on a collection of stored values for electrical load, wherein each of the stored values for electrical load has a corresponding stored value for engine speed and a stored value for a rate at which fuel is being consumed by the engine, the method comprising the steps of:
monitoring the speed of the engine and providing an input to the electronic control unit indicative of the speed;
monitoring the electrical load being supplied by the generator and providing an input to the electronic control unit indicative of the electrical load, wherein the electronic control unit determines whether the load has remained within a predetermined range for a predetermined period of time;
adjusting the speed of the engine by a predetermined amount, wherein the adjusting of the speed is accomplished by the electronic control unit providing a signal causing the fuel supplied to the engine to be adjusted;
determining the present rate at which fuel is being consumed by the engine and providing an input to the electronic control unit indicative of the rate;
comparing the present rate of fuel consumption to the stored value for the rate of fuel consumption corresponding to the electrical load being applied to the generator, wherein the electronic control unit conducts the comparison;
updating the stored value for engine speed based on the results of the comparison.

2. The method of claim 1, further comprising the step of replacing the stored value of engine speed with the present value of engine speed if the present rate of fuel consumption is less than the stored value for rate of fuel consumption.

3. The method of claim 1, wherein if the present rate of fuel consumption is greater than the stored value for the rate of fuel consumption, returning the engine speed to the speed prior to the adjustment by the predetermined amount.

4. The method of claim 1, wherein the step of adjusting includes reducing the speed of the engine.

5. The method of claim 1, wherein the step of adjusting includes increasing the speed of the engine.

6. The method of claim 3, wherein after the engine speed is returned to the speed prior to the adjusting step, the method of claim 1 is repeated.

7. A generator system including an engine and an electrical generator, wherein the system comprises:
a plurality of sensors, wherein each of the sensors senses a property of one of a fuel supply system to the engine, a speed of the engine, or an electrical load on the generator;
an electronic control unit configured to monitor and control the engine and generator; wherein each of the sensor is configured to provide a signal to the electronic control unit that is indicative of the value of the property being sensed;
wherein the electronic control unit is configured to monitor the electrical load being supplied by the generator and to determine whether the load has remained within a predetermined range for a predetermined period of time;
wherein the electronic control unit is configured to adjust the speed of the engine by a predetermined amount when the load has been determined to have remained within the predetermined range for a predetermined length of time;
wherein the electronic control unit is configured to determine the rate of fuel consumption by the engine and to compare the determined rate of fuel consumption for the adjusted speed to a stored value for the rate of fuel consumption corresponding to the electrical load being applied to the generator and subsequently update the stored value for engine speed based on the results of the comparison.

8. A variable speed engine generator set including:
a plurality of sensors including a fuel supply sensor and an electrical load sensor;
an electronic control unit configured to monitor and control the engine and generator; wherein each of the sensor is configured to provide a signal to the electronic control unit that is indicative of the value of the property being sensed;
wherein the electronic control unit is configured to monitor the electrical load being supplied by the generator and to determine whether the load has remained within a predetermined range for a predetermined period of time;
wherein the electronic control unit is configured to adjust the speed of the engine by a predetermined amount when the load has been determined to have remained within the predetermined range for a predetermined length of time;
wherein the electronic control unit is configured to compare the rate of fuel consumption for the adjusted speed to a stored value for the rate of fuel consumption corresponding to the electrical load being applied to the generator and subsequently modify the stored value for engine speed based on the results of the comparison.

9. The engine generator set of claim 8, wherein the fuel supply sensor monitors the pressure of the fuel prior to injection into an engine cylinder.

10. The engine generator set of claim 8, wherein the fuel supply sensor monitors the operation of a fuel injection system.
